(19) United States
(12) Patent Application Publication
(10) Pub. No.: US 2003/0229480 A1
(43) Pub. Date: Dec. 11, 2003

(54) Pseudo dynamic current estimating for circuits

(76) Inventor: Hendrik T. Mau, Santa Clara, CA (US)

Correspondence Address: HAMILTON & TERRILE, LLP, P.O. BOX 203518, AUSTIN, TX, 78720, US

(21) Appl. No.: 10/166,863

(22) Filed: Jun. 11, 2002

(51) Int. Cl. G06F 17/50

(52) U.S. Cl. 703/14

(57) ABSTRACT

The present disclosure relates to a method for estimating input voltages to transistors in a transistor network. The method includes identifying an input signal, to transforming a netlist, identifying input parameters and simulating a plurality of interconnected transistors. The method also can include determining if a signal is internal to a signal net, disconnecting the driver of the signal net and estimate the load based on the load of the signal net. The method also relates to circuits, specifically integrated circuits, produced by the method taught. The method is particularly applicable to the design of circuits such as VLSI integrated circuits. The disclosure also relates to electrical products such as computer systems or integrated circuit boards including a circuit designed by the method taught.

### FIELD OF THE INVENTION

The present invention relates to estimating currents in circuits, and more particularly to pseudo dynamic current estimating for integrated circuits.

### DESCRIPTION OF THE RELATED ART

Integrated circuit designers are aggressively pursuing increased performance. Specifically, recent very large scale integration (also referred to as “VLSI”) designs have achieved higher clock speeds. The higher clock speeds require greater current. Thus, the estimation of current drawn by the VLSI circuits becomes increasingly important.

Various programs, including SPICE, are used to model the behavior of a network of transistors. For a small network of resistors the input and output voltages can be modeled in a comparatively short period of time, for example, in less than two hours. For larger networks including more transistors, the time to model the input voltage to each transistor can increase. For a VLSI circuit having tens of thousands of transistors the time required to model the network to estimate the input voltage to each transistor can be many hours, perhaps overnight. For complex designs including multiple revisions the delay caused by calculating the input voltage to each transistor may cause project delays.

For complex designs, the amount of time required to model the performance of a network can be reduced by making certain approximations. An approximation can be made to simplify a network of transistors, thus reducing the time required to estimate the input voltage to each transistor. For example, such an approximation can assume that the network of transistors is a static network. This approximation is referred to as a static model in that all transistors switch simultaneously and all transistors are on and drawing a certain percentage of their IDsat current. Assuming that the network is static further assumes that all transistors switch simultaneously. In actual networks all transistors do not switch simultaneously, however, this approximation permits a reliable upper estimate of the current which flows through the network. In one application of this approximation, the estimate of the input voltage to each transistor is based on the maximum current drawn by one transistor. The static model is relatively fast compared to a model without approximations. Furthermore, the static model provides a very conservative estimate (i.e., the model predictably over estimates the voltage drop to the individual transistors, therefore identifying more, rather than fewer, transistors which potentially do not receive the minimum voltage). However, the accuracy of the static model is low. An inaccurate model can identify many more transistors as receiving sufficient voltage to operate. Thus, the static model, though requiring an acceptable amount of computing time, can cause needless redesigns to ensure all transistors receive sufficient input voltage.

Another approximation which is more accurate but requires comparably more computing time is a dynamic model. The dynamic model determines the switching time of each transistor in a cycle. The dynamic model determines the input voltage to each transistor using a vector file to describe the behavior of the input signals as a function of time. The number of input vectors is approximately equal to the number of input signals which is based upon the number for transistors. Therefore, for a VLSI design the number of vectors required to compile a vector file may be prohibitive. One method of reducing the input vectors is by attempting to identify the input vectors for the transistors consuming the largest amount of current. After identifying these vectors, designers estimate the voltage to the network based on the input vector file to the transistors assumed to be drawing the largest amount of current. The dynamic model requires more computing time than the static model and also provides a conservative estimate of the voltage input to each transistor and also provides a conservative estimate of the input voltage to each transistor by carefully choosing the worst case input vector. However, the dynamic model is less-than ideal due to time and accuracy considerations.

Integrated circuits are designed using computer-aided design (CAD) tools. The integrated circuit design process includes constructing the integrated circuit design out of simple circuits (standard cells) that are connected together electrically using interconnects. The standard cells and connections between them are stored in databases called “netlists” (i.e., lists of symbolic interconnections (i.e., nets)). The netlist defines all of the interconnections between the components of the circuit. Each “signal” which interconnects two or more cells, or which represents an input or output for the entire circuit, is actually a node in the circuit which has been assigned a name. Thus the terms “signal”, “node” and “net” are often used interchangeably. Nodes may be input nodes, output nodes or internal nodes.

### SUMMARY OF THE INVENTION

The present invention relates to estimating current draw in an integrated circuit which includes: identifying individual signal nets from a netlist; transforming the individual signal nets; writing a new simulation deck based upon the transformed individual signal nets; executing a simulation using the new simulation deck which produce simulation results that included predicted current draw for the new simulation deck; and, examining the predicted current draw to identify potential current draw problems.

In one embodiment, the invention relates to an apparatus for estimating current draw in an integrated circuit which includes: means for identifying individual signal nets from a netlist; means for transforming the individual signal nets; means for writing a new simulation deck based upon the transformed individual signal nets; means for executing a simulation using the new simulation deck which produce simulation results that include predicted current draw for the new simulation deck; and, means for examining the predicted current draw to identify potential current draw problems.

In another embodiment, the invention relates to estimating current draw in an integrated circuit which includes: an identify module, a transform module, a write module, an execute module and an examine module. The identify module identifies individual signal nets from a netlist. The transform module transforms the individual signal nets. The write module writes a new simulation deck based upon the transformed individual signal nets. The execute module executes a simulation using the new simulation deck that produces simulation results which include predicted current draw for the new simulation deck. The examine module examines the predicted current draw to identify potential current draw problems.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 shows an example of a circuit to be modeled.

FIG. 2 shows a schematic diagram of a model of the circuit of FIG. 1.

FIG. 3 shows a flow chart of a method for estimating the current drawn by a circuit.

FIG. 4 shows a flow chart for a scan netlist module of the method of FIG. 3.

FIG. 5 shows a flow chart of a transform netlist module of the method of FIG. 3.

FIG. 6 shows a flow chart of another transform netlist module of the method of FIG. 3.

The disclosure contains, by necessity, simplifications, generalizations and omissions of detail; consequently, those skilled in the art will appreciate that the disclosure is illustrative only and is not intended in any way to be limiting.

### DETAILED DESCRIPTION

The following sets forth a detailed description of a mode for carrying out the invention. The description is intended to be illustrative of the invention and should not be taken to be limiting. A method is taught to estimate the current drawn by a circuit of transistors. From the current distribution, the voltage drop can be calculated. When the current and voltage distribution is known, the input voltage to each transistor can be determined. Determining the input voltage to a transistor allows a designer to readily determine if the transistor has the minimum voltage required for reliable operation. In one embodiment, the method is used to determine the input voltage to transistors in a VLSI design.

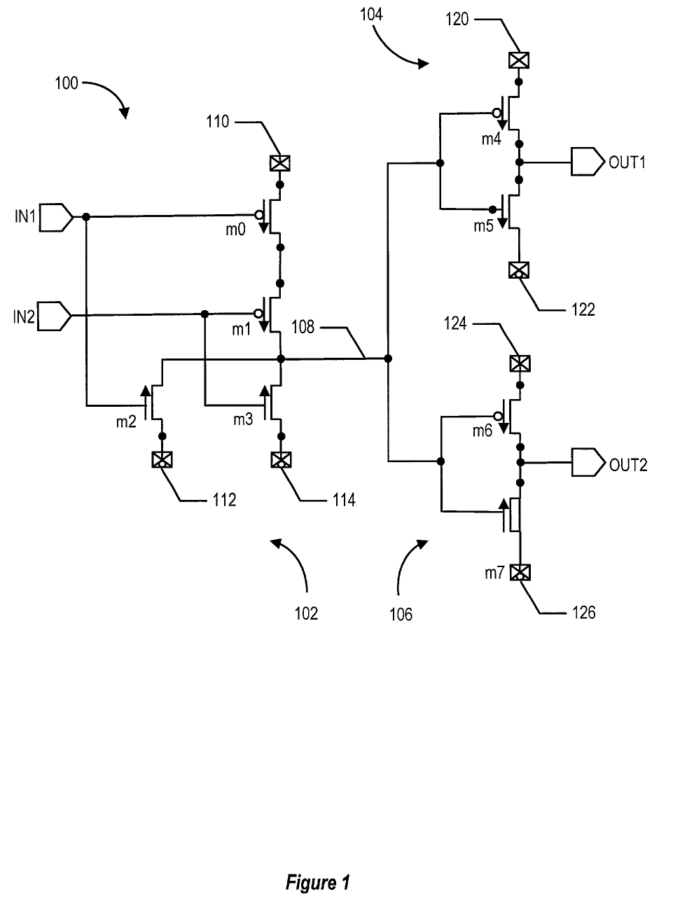

FIG. 1 shows a simplified example of a circuit for which current draw is to be estimated. Circuit 100 receives two input signals, IN1 and IN2. Circuit 100 provides two output signals OUT1 and OUT2. Additionally, circuit 100 includes a plurality of connection points which represent points where circuit 100 is coupled to other circuits. Circuit 100 may be conceptualized as a plurality of sub-circuits 102, 104, 106. Sub-circuit 102 receives the input signals IN1 and IN2 and provides an intermediate output signal at internal node 108. Sub-circuit 104 receives the intermediate output signal and provides the output signal OUT1. Sub-circuit 106 receives the intermediate output signal and provides the output signal OUT2.

Input signal IN1 is coupled to the gates of transistors m0 and m2. Input signal IN2 is coupled to the gates of transistors m1 and m3. The source of transistor m0 is coupled to the drain of transistor m1. The drain of transistor m1 is coupled to the drain of transistor m3. The drain of transistor m2 is coupled to the drains of transistors m1 and m3; this connection also provides the intermediate output signal via internal node 108 to the next stage of circuit 100. The sources of transistors m0, m2 and m3 are each coupled to respective connection points 110, 112, 114.

The internal node 108 is coupled to the gates of transistors m4 and m5. The drain of transistor m4 is coupled to the drain of transistor m5 to provide the output signal OUT1. The sources of transistors m4 and m5 are each coupled to respective connection points 120 and 122.

The internal node 108 is coupled to the gates of transistors m6 and m7. The drain of transistor m6 is coupled to the drain of transistor m7 to provide the output signal OUT2. The sources of transistors m6 and m7 are each coupled to respective connection points 124 and 126.

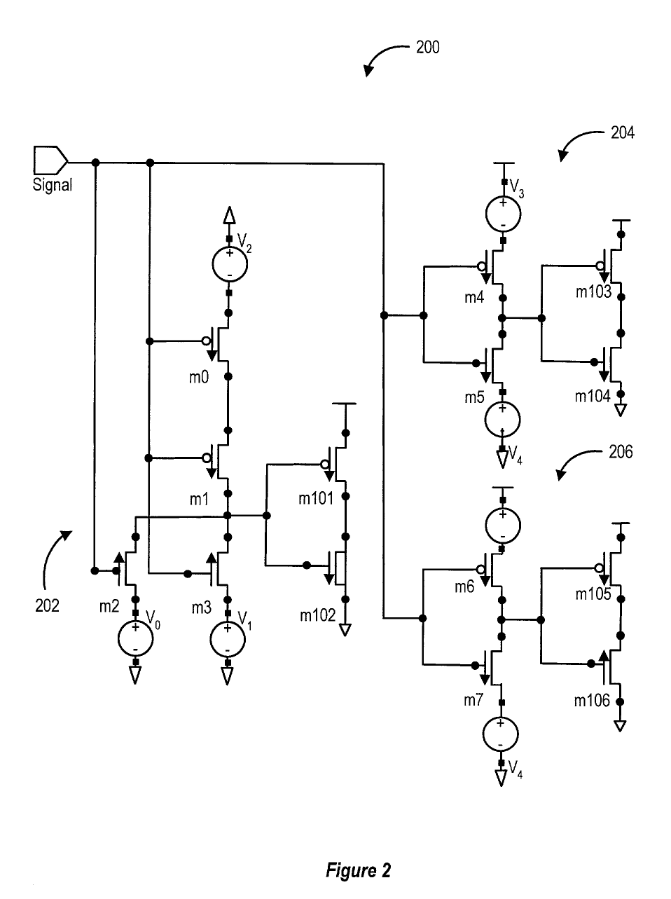

FIG. 2 shows circuit 200 which is derived from circuit 100 using the method of the present invention. In circuit 200, the sub-circuits 102, 104 and 106 are conceptually separated and represented as sub-circuits 202, 204 and 206 so that the sub-circuits can be used to estimate individual current draw. Each sub-circuit includes an output to mimic the load on the output of the sub-circuit. Additionally, the input signals IN1 and IN2 are combined as a single signal (SIGNAL) which is distributed to all sub-circuits to simulate all inputs being simultaneously activated. Thus, the need for a specific input vector is avoided and all gates are switched substantially simultaneously. Additionally, the connection points are represented as individual voltage sources, which are coupled to either power or ground. Thus, each sub-circuit is a separately controllable entity.

More specifically, the load at internal load 108 is represented by transistors m101 and m102. The width of transistor m101 is the combination of the width of transistor m4 and m6 of circuit 100. The width of transistor 102 is the combination of the width of transistor m5 and transistor m7.

Additionally, output signal OUT1 is represented by transistor m103 and transistor m104. The width of transistors m103 and m104 are chosen to represent the load placed on the circuit 100 by devices coupled to receive output signal OUT1.

Additionally, output signal OUT2 is represented by transistor m105 and transistor m106. The width of transistors m105 and m106 are chosen to represent the load placed on the circuit 100 by devices coupled to receive output signal OUT2.

Sub-circuit 202 also includes representations of voltage sources 220, 222 and 224. These voltage sources represent the voltage that is applied to circuit 100 by connection points 110, 112 and 114, respectively.

Sub-circuit 204 includes representations of voltage sources 230 and 232. These voltage sources represent the voltage that is applied to circuit 100 by connection points 120 and 122, respectively.

Sub-circuit 206 includes representations of voltage sources 240 and 242. The voltage sources represent the voltage that is applied to the circuit 100 by connection points 124 and 126.

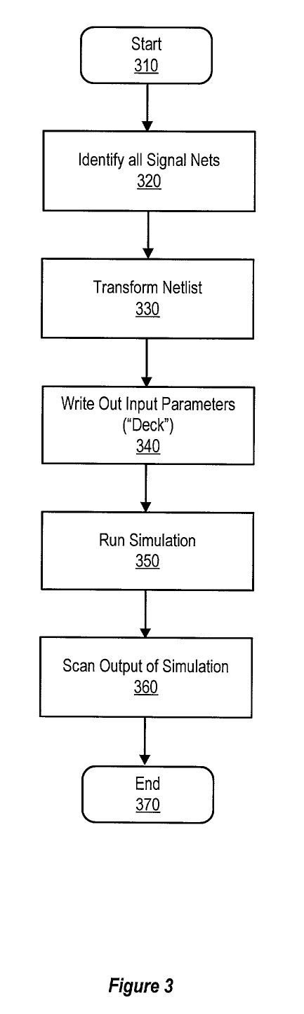

Referring to FIG. 3, a flow chart of the method for pseudo dynamic estimating of current draw in a network of circuits is shown. With the method of pseudo dynamic estimating of current draw all transistors switch substantially simultaneously without the need for an input vector (i.e., the transistors switch vectorlessly). The method starts by identifying all signal nets in a netlist at scan netlist step 320.

After the signal nets are identified, the individual signal nets in the netlist are transformed at transform netlist step 330. After the netlist is transformed, the method writes out the input deck at step 340. Step 340 generates a new configuration of the circuits to include the new inputs and additional transistors that were developed during the transform netlist step 330. A simulation (such as a SPICE simulation) is executed at step 350. Next, after the simulation is executed, the output currents of the simulation are scanned at step 360. After the output of the simulation is scanned and any potential current draw problems are identified the operation completes at end step 370.

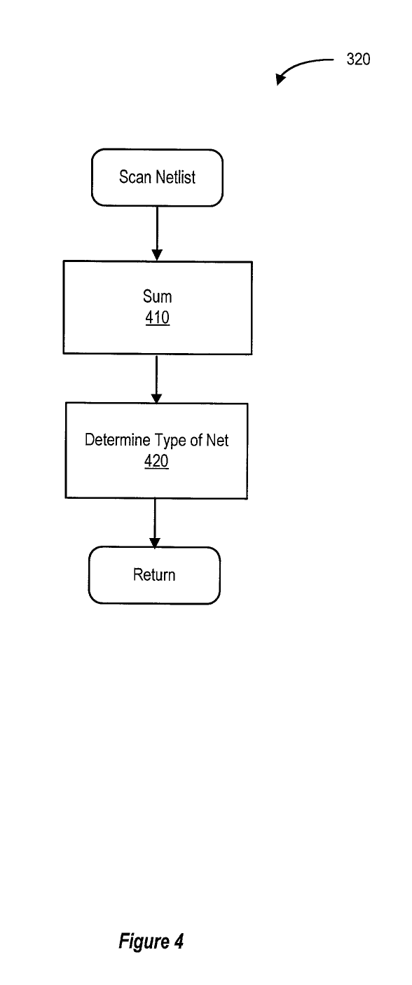

Referring to FIG. 4, a flow chart showing the execution of the scan netlist step 320 is shown. More specifically, when the scan netlist step executes, during sum step 410, the method sums up for every net, the width of the transistors attached to the net. These transistors are indexed by transistor type and by the contact node via which the transistor is attached to the net. After the sum step completes, then the method determines the type of net depending on the transistor widths summed during the sum step at determine type of net step 420. There are four types of nets: input, output, internal signal and internal net. Input nets are only connected to gates. Output nets are connected to a point between a PMOS and a NMOS only. Internal signal nets are connected to gates and to a point between a PMOS and a NMOS. Internal nets are all other connections. For example, internal nets may be the connection between stacked PMOS's or NMOS's in NAND or NOR gates. After the determine step completes control returns to the method.

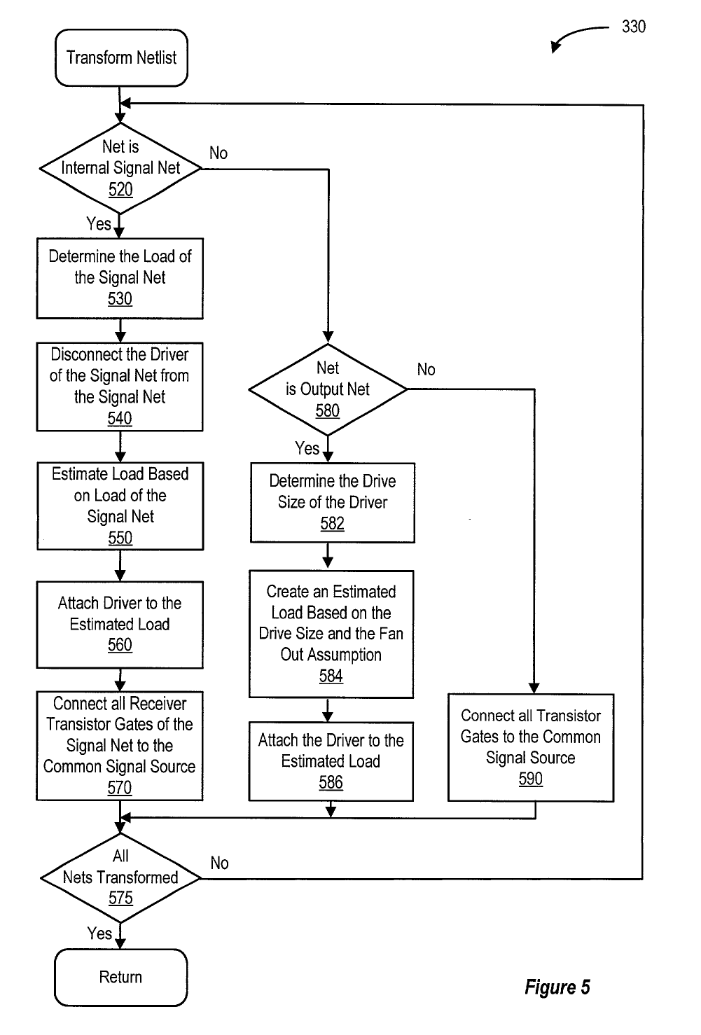

Referring to FIG. 5, a flow chart showing the execution of the transform netlist step 330 is shown. More specifically, the method first determines whether the net is an internal signal net at step 520. If the net is an internal signal net, then next the system determines the load of the signal net at step 530. After the load is determined then the method disconnects the driver of the signal net from the signal net at step 540. After the driver of the signal is disconnected, then the method estimates the load based on the load of the signal net at step 550. After the load is estimated, then a driver is attached to the estimated load at step 560. After the driver is attached, then all receiver transistor gates of the signal net are connected to a common signal source at step 570. Next the method determines whether all nets within the circuit have been transformed at step 575. If all nets have not yet been transformed, then control returns to determine step 520.

If at determine step 520, the method determines that the net is not an internal signal net, then the method analyzes the net to determine whether the net is an output net at step 580. If the net is an output net then the method determines the drive size of the driver at step 582. Next the method creates an estimated load based on the driver size and a fan out assumption at step 584. Next the method attaches the driver to the estimated load at step 586. Next control transfers to determine step 575 where the method determines whether all nets of the circuit have been transformed.

If at step 580, the method determines that the net is not an output net, then the method connects all transistor gates to the common signal source at step 590. The net not being an internal signal net as determined by step 520 and not being an output net as determined by step 580 indicates that the net is an input net. After all transistor gates are connected to the common signal source, then the determine step 575 determines whether all nets have been transformed. When all of the nets have been transformed, then execution of the transform netlist module completes and control returns to method 300.

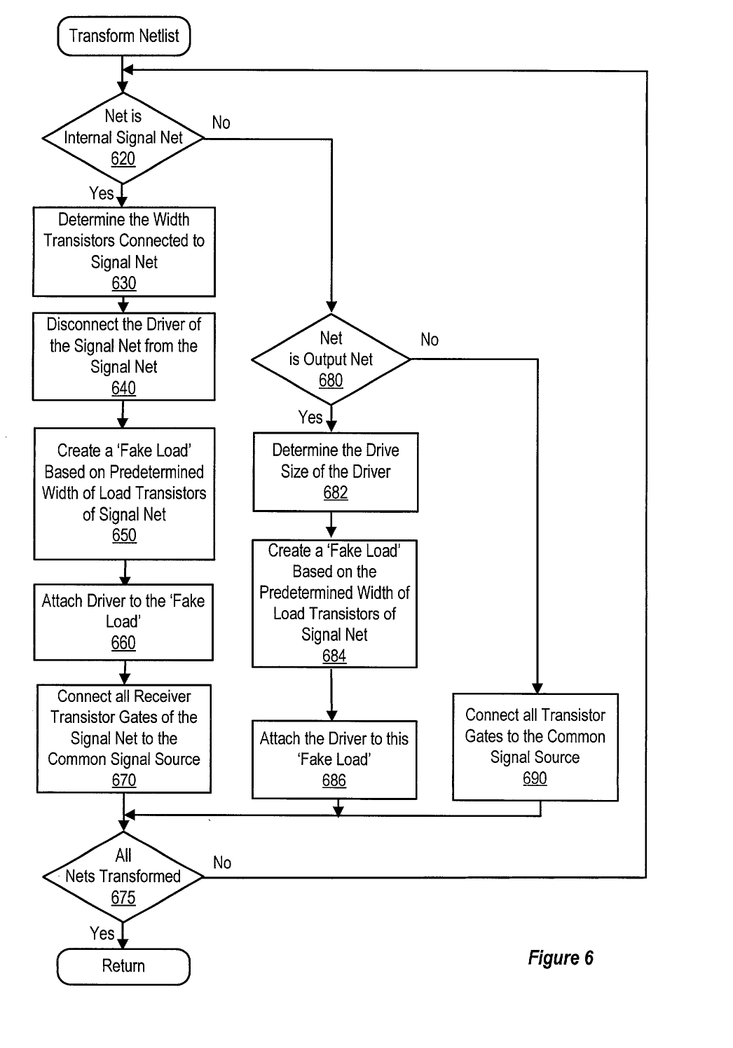

Referring to FIG. 6, a flow chart showing the execution of the transform netlist step 330 in which the circuit is assumed to not contain any parasitic elements (i.e., the load of a signal net includes only MOS transistors) is shown. More specifically, the method first determines whether the net is an internal signal net at step 620. If the net is an internal signal net then next the method determines the width of the transistors connected to the signal net at step 630. After the width is determined, then the method disconnects the driver of the signal net from the signal net at step 640. After the driver of the signal is disconnected, then the method creates a “fake load” (i.e., a simulated load) based on the predetermined width of the load transistors of the signal net at step 650. After the load is created, then a driver is attached to the load at step 660. After the driver is attached, then all receiver transistor gates of the signal net are connected to a common signal source at step 670. Next the method determines whether all nets within the circuit have been transformed at step 675. If all nets have not yet been transformed, then control returns to determine step 620.

If at determine step 620, the method determines that the net is not an internal signal net, then the method analyzes the net to determine whether the net is an output net at step 680. If the net is an output net then the method determines the drive size of the driver at step 682. Next the method creates a “fake load” based on the predetermined width of the load transistors of the signal net at step 684. Next the method attaches the driver to the load at step 686. Next control transfers to determine step 575 where the method determines whether all nets of the circuit have been transformed.

If at step 680, the method determines that the net is not an output net, then the method connects all transistor gates to the common signal source at step 690. The net not being an internal signal net as determined by step 620 and not being an output net as determined by step 680 indicates that the net is an input net. After all transistor gates are connected to the common signal source, then the determine step 675 determines whether all nets have been transformed. When all of the nets have been transformed, then execution of the transform netlist module completes and control returns to method 300.

Other Embodiments

Other embodiments are within the following claims.

The method disclosed is not restricted to a specific software, software language or software architecture. Each of the steps of the method disclosed may be performed by a module (e.g., a software module) or a portion of a module executing on a computer system. Thus, the above component organization may be executed on a laptop, desk top or other computer system. The method may be embodied in a machine-readable and/or computer-readable medium for configuring a computer system to execute the method. Thus, the software modules may be stored within and/or transmitted to a computer system memory to configure the computer system to perform the functions of the module.

It is appreciated that operations discussed herein may include, for example, directly entered commands by a computer system user, steps executed by application specific hardware modules, steps executed by software modules, or combinations thereof.

The software discussed which performs the described steps may include script, batch or other executable files, or combinations and/or portions of such files. The software may include software code as well as data and may be encoded on computer-readable media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described herein are for illustration only. Operations may be combined or the functionality of the operations may be distributed in additional operations in accordance with the invention.

The operations described and modules may be executed on a computer system configured to execute the operations of the method and/or may be executed from computer-readable media. The method may be embodied in a machine-readable and/or computer-readable medium for configuring a computer system to execute the method. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Also, in the present invention, a MOS transistor may be conceptualized as having a control terminal which controls the flow of current between a first current handling terminal and a second current handling terminal. Although MOS transistors are frequently discussed as having a drain, a gate, and a source, in most such devices the drain is interchangeable with the source. This is because the layout and semiconductor processing of the transistor is symmetrical (which is typically not the case for bipolar transistors). For an N-channel MOS transistor, the current handling terminal normally residing at the higher voltage is customarily called the drain. The current handling terminal normally residing at the lower voltage is customarily called the source. A sufficient voltage on the gate causes a current to therefore flow from the drain to the source. The gate to source voltage referred to in an N-channel MOS device equations merely refers to whichever diffusion (drain or source) has the lower voltage at any given time. For example, the “source” of an N-channel device of a bi-directional CMOS transfer gate depends on which side of the transfer gate is at a lower voltage. To reflect the symmetry of most N channel MOS transistors, the control terminal is the gate, the first current handling terminal may be termed the “drain/source”, and the second current handling terminal may be termed the “source/drain”. Such a description is equally valid for a P channel MOS transistor, since the polarity between drain and source voltages, and the direction of current flow between drain and source, is not implied by such terminology. Alternatively, one current handling terminal may be arbitrarily deemed the “drain” and the other deemed the “source”, with an implicit understanding that the two are not distinct, but interchangeable.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims.

What is claimed is:

1. A method for estimating current draw in an integrated circuit comprising:
identifying individual signal nets from a netlist;
transforming the individual signal nets writing a new simulation deck based upon the transforming the individual signal nets;
executing a simulation using the new simulation deck, the simulation producing simulation results, the simulation results including predicted current draw for the new simulation deck; and,
examining the predicted current draw to identify potential current draw problems.

2. The method for estimating current draw of claim 1 wherein:
the identifying individual signal nets from a netlist includes executing a scan netlist module.

3. The method for estimating current draw of claim 2 wherein:
the executing the scan netlist module includes
summing the width of transistor attached to the net; and,
determining a type of net depending on the transistor widths.

4. The method for estimating current draw of claim 1 wherein:
the transforming includes
determining whether the net is an internal signal net; and when the net is an internal signal net,
determining a load of the signal net;
disconnecting a driver of the signal net from the signal net;
estimating a load based on the load of the signal net; and
attaching a driver to the estimated load.

5. The method for estimating current draw of claim 4 wherein:
gates are connected to the signal net, the gates including a gate width;
the determining a load of the signal net further includes determining the width of gates connected to the signal net; and
the estimating the load includes creating a load based on the width of the gates connected to the signal net.

6. The method for estimating current draw of claim 1 wherein:
the transforming includes
connecting all receiver gates of the signal net to a common signal source

7. The method for estimating current draw of claim 1 wherein:
the transforming includes
determining whether the net is an output signal net; and when the net is an output signal net,
determining a drive size of a driver;
creating a load based upon a predetermined drive size and fan out assumption; and
attaching the driver to the load.

8. An apparatus for estimating current draw in an integrated circuit comprising:
means for identifying individual signal nets from a netlist;
means for transforming the individual signal nets
means for writing a new simulation deck based upon the transforming the individual signal nets;
means for executing a simulation using the new simulation deck, the simulation producing simulation results, the simulation results including predicted current draw for the new simulation deck; and,
means for examining the predicted current draw to identify potential current draw problems.

9. The apparatus for estimating current draw of claim 8 wherein:
the means for identifying individual signal nets from a netlist includes means for executing a scan netlist module.

10. The apparatus for estimating current draw of claim 9 wherein:
the means for executing the scan netlist module includes
means for summing the width of transistor attached to the net; and,
means for determining a type of net depending on the transistor widths.

11. The apparatus for estimating current draw of claim 8 wherein:
the means for transforming includes
means for determining whether the net is an internal signal net; and when the net is an internal signal net,
means for determining a load of the signal net;
means for disconnecting a driver of the signal net from the signal net;
means for estimating a load based on the load of the signal net; and
means for attaching a driver to the estimated load.

12. The apparatus for estimating current draw of claim 11 wherein:
gates are connected to the signal net, the gates including a gate width;
the means for determining a load of the signal net further includes
means for determining the width of gates connected to the signal net; and
the means for estimating the load includes creating a load based on the width of the gates connected to the signal net.

13. The method for estimating current draw of claim 8 wherein:
the means for transforming includes
means for connecting all receiver gates of the signal net to a common signal source

14. The method for estimating current draw of claim 8 wherein:
the means for transforming includes
means for determining whether the net is an output signal net; and when the net is an output signal net,
means for determining a drive size of a driver;
means for creating a load based upon a predetermined drive size and fan out assumption; and
means for attaching the driver to the load.

15. A system for estimating current draw in an integrated circuit comprising:
an identify module, the identify module identifying individual signal nets from a netlist;
a transform module, the transform module transforming the individual signal nets
a write module, the write module writing a new simulation deck based upon the transforming the individual signal nets;
an execute module, the execute module executing a simulation using the new simulation deck, the simulation producing simulation results, the simulation results including predicted current draw for the new simulation deck; and,
an examine module, the examine module examining the predicted current draw to identify potential current draw problems.

16. The system for estimating current draw of claim 15 wherein:
the identifying individual signal nets from a netlist includes executing a scan netlist module.

17. The system for estimating current draw of claim 16 wherein:
the execute module includes
a sum module, the sum module summing the width of transistor attached to the net; and,
a determine module, the determine module determining a type of net depending on the transistor widths.

18. The system for estimating current draw of claim 15 wherein:
the transform module includes
a determine width module, the determine module determining whether the net is an internal signal net; and when the net is an internal signal net,
a determine load module, the determine load module determining a load of the signal net;
a disconnect module, the disconnect module disconnecting a driver of the signal net from the signal net;
an estimate module, the estimate module estimating a load based on the load of the signal net; and
an attach module, the attach module attaching a driver to the estimated load.

19. The system for estimating current draw of claim 18 wherein:
gates are connected to the signal net, the gates including a gate width;
the determining a load of the signal net further includes determining the width of gates connected to the signal net; and
the estimating the load includes creating a load based on the width of the gates connected to the signal net.

20. The system for estimating current draw of claim 15 wherein:
the transform module includes
a connect module, the connect module connecting all receiver gates of the signal net to a common signal source

21. The system for estimating current draw of claim 15 wherein:
the transform module includes
a determine net module, the determine net module determining whether the net is an output signal net; and when the net is an output signal net,
a determine driver size module, the determine driver size module determining a drive size of a driver;
a create load module, the create load module creating a load based upon a predetermined drive size and fan out assumption; and
an attach module, the attach module attaching the driver to the load.
